(19) United States
(12) Patent Application Publication
(10) Pub. No.: US 2008/0302436 A1
(43) Pub. Date: Dec. 11, 2008

(54) Tripod leg covers

(76) Inventor: Scott Elowitz, Freehold, NJ (US)

Correspondence Address: ARTHUR M. PESLAK, ESQ.;MANDEL & PESLAK, LLC, SUITE 5, 80 SCENIC DRIVE, FREEHOLD, NJ, 07728-5211, US

(21) Appl. No.: 11/810,181

(22) Filed: Jun. 5, 2007

(51) Int. Cl. F16L 11/00

(52) U.S. Cl. 138/110; 138/167; 138/128

(57) ABSTRACT

What is disclosed is a cover for a still or video camera tripod. The tapered leg covers comprise a foam core, a neoprene cover and a means to secure the cover to the tripod legs.

### BACKGROUND OF THE INVENTION

The present invention is directed to the field of covers used on the legs of camera tripods. In particular, the present invention is particularly directed to covers used on tripods primarily by persons who photograph outdoors, such as nature photographers. The covers are useful for a variety of reasons in that they provide padding when the user carries the tripod on his or her shoulder while walking distances.

The presently available tripod leg covers suffer from many defects. The available tripod leg covers are not soft with a cushiony feel when carried, the leg covers tend to rotate relative to the tripod legs, and the available covers have an exterior fabric cover that tends to rip and tear. It is an object of the present invention to solve the problems with the prior tripod leg covers by providing a soft, cushiony cover with an exterior neoprene cover that does not tear and with the ability to prevent rotation relative to the tripod when mounted thereon.

### SUMMARY OF THE INVENTION

Covers adapted for installation on tripod legs comprising an elongated, generally cylindrical shaped core comprising an elongated longitudinal slot therein and mounting means on its interior surface; and an exterior neoprene cover adapted to fit over the generally cylindrical shaped core comprising a strap adapted to secure the neoprene cover to the cylindrical core and a closure means on its ends wherein the longitudinal slot is adapted to receive the tripod legs, the mounting means are adapted to secure the core to the tripod legs and the closure is adapted to secure the exterior cover to the core and thereby secure the covers to the tripod legs.

### BRIEF DESCRIPTION OF THE DRAWINGS

FIG. 1 is a plan view of the exterior of an embodiment of the present invention.

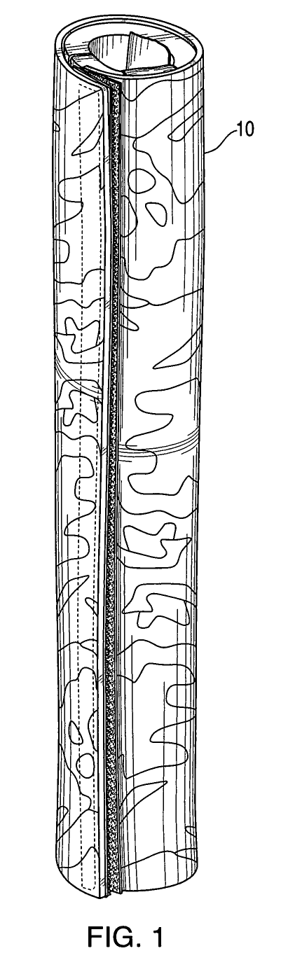

FIG. 2 is an exploded view illustrating the interior of an embodiment of the present invention.

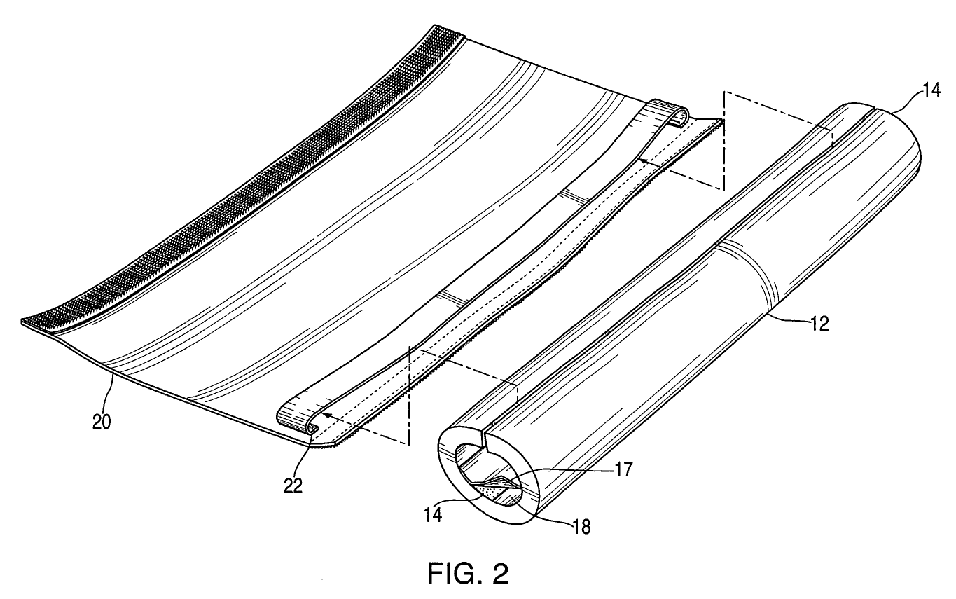

FIG. 3 is an exploded view illustrating an alternate interior view of an embodiment of the present invention.

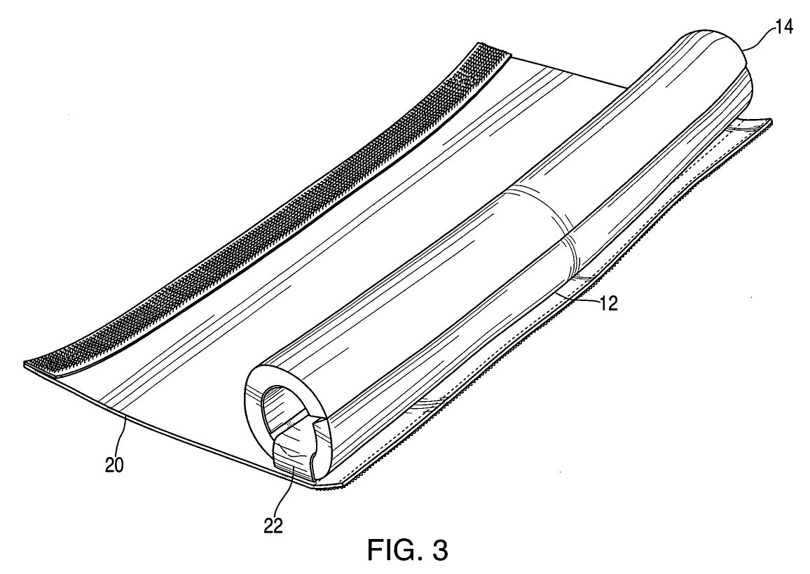

FIG. 4 illustrates another plan view of the present invention.

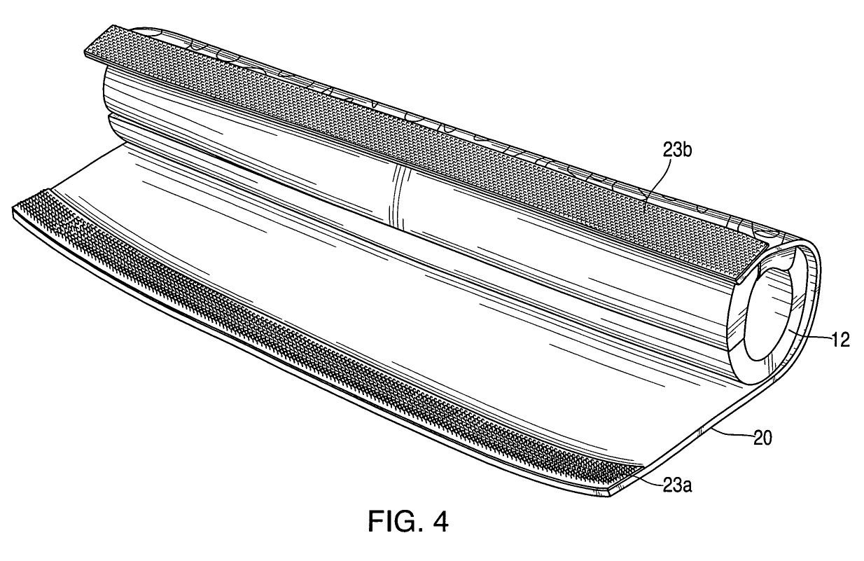

FIG. 5 illustrates an embodiment of the present invention as installed on a tripod.

### DETAILED DESCRIPTION OF THE INVENTION

The present invention will now be described in terms of the presently preferred embodiment thereof. Those of ordinary skill in the art will recognize that many obvious changes may be made thereto without departing from the spirit or scope of the present invention.

The present invention is directed to padded leg covers that are used in connection with a tripod. The tripod can be used to support a still camera, a video camera, a spotting scope or any other appropriate device. Generally, the tripod legs are composed of a plurality of telescoping leg sections so that the tripod is expandable to the appropriate height for the user.

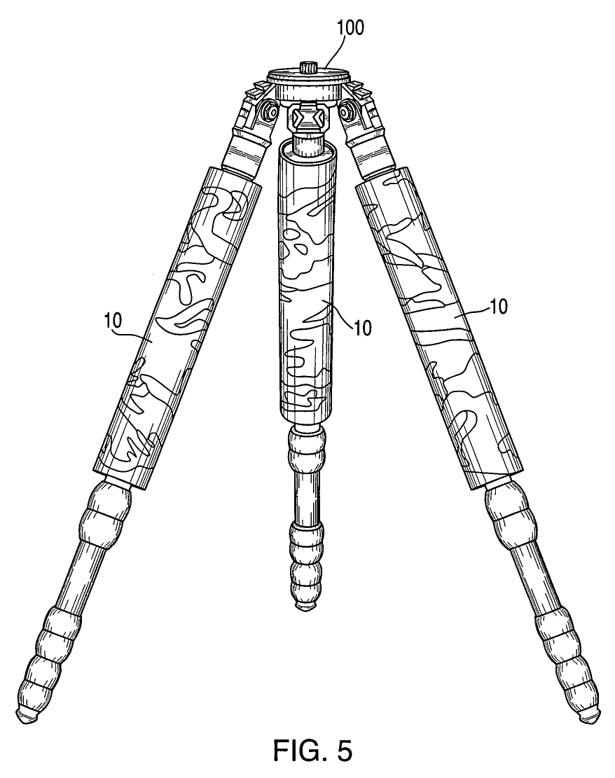

The tripod leg covers 10 are illustrated in the drawings. The leg covers 10 are generally adapted to be installed on the upper leg section of the tripod 100 as illustrated in FIG. 5.

The tripod leg covers 10 comprise a hollow cylindrically shaped foam core 12. The foam core 12 is fabricated from polyethylene but any similarly appropriate material may be substituted. The foam core 12 contains a longitudinal slot 14 along its outer edge. A strip of double-sided tape 16 is mounted on the internal surface 18 of the foam core 12. The double-sided tape 16 is provided with a sheet of removable covering paper 17 over one side of the double-sided tape 16.

The tripod leg covers 10 further comprise a neoprene cover 20. The neoprene cover 20 is generally rectangular in shape. The neoprene cover 20 comprises an elastic strap 22 and a hook and loop closure 23a and 23b on the edges thereof. In this embodiment, the neoprene cover 20 is printed with a camouflage pattern on its exterior, which is useful for nature photographers who wish to conceal themselves from birds or animals.

The foam core 12 is removeably secured to the neoprene cover 20 by sliding the elastic strap 22 through the longitudinal slot 14. The neoprene cover is then wrapped around the foam core 12 and closed thereon by the hook and loop closures 23a and 23b on its edges.

The assembled tripod leg covers 10 can be installed onto the tripod 100 as shown in FIG. 5. In order to do so, the user would open the hook and loop closure 23a and 23b and then open the foam core 12 at the longitudinal slot 14. At that point, the user would remove the covering paper 17 from the double-sided tape 16. The user would then insert the tripod leg covers 10 over the upper section of the tripod legs at the desired location.

Next, the user would close the slot 14 and the double-sided tape 16 will cause the foam core 12 to stick to the tripod legs. The neoprene cover 20 would then be wrapped around the outside of the foam core 12 and closed at the hook and loop closure 23a and 23b.

At this point, the tripod leg covers 10 would be securely installed on the upper leg section of the tripod 100. The double-sided tape 16 will act to prevent rotation of the tripod leg cover 10 with respect to the tripod itself. The combination of the foam core 12 and the soft neoprene cover 20 will provide a soft cushiony feel to the tripod. Most users carry the tripod 100 with a camera mounted thereon on their shoulder. The weight of a camera and lens combination for nature photography could be over ten pounds. Thus, the tripod leg covers 10 provide a comfortable way to carry the heavy load on one's shoulders. In addition, the tripod leg covers 10 provide insulation from the cold during winter weather when the tripod legs can become quite cold.

Those of ordinary skill in the art will recognize that the foregoing merely describes an embodiment of the present invention and that many obvious modifications may be made thereto without departing from the spirit or scope of the present invention as set forth in the appended claims.

What is claimed is:

1. Covers adapted for installation on tripod legs comprising:
(a) An elongated, generally cylindrically shaped core comprising an elongated longitudinal slot therein and mounting means on its interior surface; and
(b) An exterior cover adapted to fit over the generally cylindrically shaped core comprising a strap adapted to secure the exterior cover to the cylindrical core and a closure means on its ends;
wherein the longitudinal slot is adapted to receive the tripod legs, the mounting means are adapted to secure the core to the tripod legs and the closure is adapted to secure the exterior cover to the core and thereby secure the covers to the tripod legs.

2. The covers of claim 1 wherein the mounting means comprises double-sided tape.

3. The covers of claim 1 wherein the exterior cover is fabricated from neoprene.
